(19) United States
(12) Patent Application Publication
(10) Pub. No.: US 2019/0016105 A1
(43) Pub. Date: Jan. 17, 2019

(54) EDGE CURE FOR DISPLAY ASSEMBLIES HAVING A MASKED TRANSPARENT ADHESIVE

(71) Applicant: 3M INNOVATIVE PROPERTIES COMPANY, St. Paul, MN (US)

(72) Inventor: Andrew J. Ouderkirk, Kirkland, WA (US)

(73) Assignee: 3M INNOVATIVE PROPERTIES COMPANY, St. Paul, MN (US)

(21) Appl. No.: 16/069,312

(22) PCT Filed: Jan. 17, 2017
(86) PCT No.: PCT/US2017/013699

§ 371 Date: Jul. 11, 2018

Related U.S. Application Data
(60) Provisional application No. 62/280,284, filed on Jan. 19, 2016.

(51) Int. Cl. B32B 37/12; G02F 1/13; G02F 1/1333; B32B 37/00

(52) U.S. Cl. CPC B32B 37/12; G02F 1/1303; G02F 1/133308; B32B 37/0076; B32B 2038/0076; G02F 2001/133325; G02F 2202/28; B32B 2037/1253; G02F 2001/133331

(57) ABSTRACT

A technique for producing a bonded display assembly uses actinic radiation from a series of discrete LEDs, and an anamorphic optical system. The display assembly comprises a cover glass, a display housing, and an initially uncured adhesive layer. A peripheral mask lies between the adhesive layer and the cover glass, such that corresponding peripheral portions of the adhesive layer are masked from direct illumination through the cover glass. Actinic light from the LEDs is injected into a first masked portion of the adhesive layer through an adhesive edge, after such light passes through or is otherwise redirected by the anamorphic optical system. The anamorphic optical system, such as one or more cylindrical lenses, is configured such that the redirected light (a) spreads out along the adhesive edge, and (b) is focused onto the adhesive edge in a reference plane perpendicular to the adhesive edge.

### FIELD OF THE INVENTION

This invention relates generally to liquid crystal displays and the like, and assemblies and subassemblies thereof, and methods of making such displays and assemblies. The invention also relates to associated articles, systems, and methods.

### BACKGROUND

Liquid crystal display (LCD) devices are ubiquitous in the modern world. They can be found in numerous products ranging from mobile phones and smart phones to gaming devices, tablet and laptop computers, TVs, watches, and many other portable and semi-portable electronic devices that display images or other information on a screen. The devices use a layer of liquid crystal (LC) material sealed between two transparent plates, and two polarizers on opposite sides of the LC layer. This subassembly of layers and components is referred to herein as a display housing.

The LCD devices also often include a front transparent protective or reinforcing layer which we refer to herein as a cover glass. The cover glass may be made of glass, and is thick or robust enough to adequately protect the display housing from dust, chemicals, abrasion, and other potentially harmful agents, or to provide rigidity or stiffness to reinforce the display housing, or both. The cover glass substantially completely covers the upper or front exposed surface of the display housing. The cover glass permanently attaches to the display housing by a transparent adhesive bonding layer. The adhesive is transparent to permit viewing of the display, since a large central portion of the adhesive layer is in the active or useful area of the display screen, defined by the useable display area of the display housing. During manufacture of the LCD device the transparent adhesive is initially applied in an uncured state, in some cases as a liquid. The transparent adhesive is later cured, e.g. by heat, ultraviolet (UV) light, or a combination of both (depending on the composition of the adhesive), to make the bond between the cover glass and the display housing permanent and robust.

In devices of interest, an opaque mask layer is printed on a marginal or peripheral portion of the cover glass. The mask layer may for example have a generally rectangular shape similar in appearance to a narrow picture frame, when viewed from the standpoint of an ordinary observer of the LCD device. The mask layer blocks, hides, or otherwise conceals certain components of the display housing—such as light sources, mechanical systems, and electrical components that form the bezel of the display—so they cannot be seen by the ordinary observer.

The mask layer however can interfere with the curing of the adhesive layer, particularly at the margins or periphery of the cover glass for an adhesive that relies on UV light as one of the curing agents, or as the only curing agent. This is because the UV light used for curing is typically directed at the adhesive layer through the cover layer, and therefore also through the mask layer. This approach gives rise to a shadowing effect by the mask layer that greatly reduces the intensity of the UV light in the portion of the adhesive layer under the mask. The shadowing effect can result in one or more of: longer curing times; greatly increased UV light intensity used for curing; or only partial curing of the shadowed portion of the adhesive layer. An adhesive that is not fully cured can lead to toxicity and sensitization concerns for users.

One proposed solution to this problem is disclosed in U.S. Pat. No. 8,599,342 (Kobayashi et al.). Kobayashi describes, among other things, irradiating the photocuring resin from only a side surface of the resin layer. In discussing the light source that is used to do the irradiating, Kobayashi says it may be arranged along the whole long side of the rectangular laminated body, and further, the light source may be formed of a small light source such as a point light source, and the light may be irradiated to the laminated body while moving the light source in an extending direction of a long side of the laminated body.

### BRIEF SUMMARY

We recognize that the Kobayashi technique results in an effective cure depth that is substantially larger than the standard technique because curing takes place from the edge rather than the front of the structure, leading to a lower degree of cure, as well as a spatially non-uniform cure and a resulting development of non-uniform stresses. Such stresses can create color non-uniformity in the finished display.

We describe techniques for bonding a masked cover glass to a display housing using a transparent curable adhesive layer, where curing of the adhesive layer is accomplished using, at least, a series of discrete LEDs in combination with an anamorphic optical system such as one or more cylindrical lenses or mirrors. Actinic radiation, such as blue, violet, or UV light from the LEDs, is captured by the anamorphic optical system and redirected into the adhesive layer through a narrow side surface or edge of the adhesive layer. The anamorphic optical system allows the captured LED light to spread out along the adhesive edge, while also focusing such light in a plane perpendicular to the adhesive edge. This provides a beam of curing radiation that is both high intensity and that has a good spatially uniformity along the edge of the adhesive layer.

Furthermore, we disclose techniques for producing a bonded display assembly using actinic radiation from a series of discrete LEDs, and an anamorphic optical system. The display assembly comprises a cover glass, a display housing, and an initially uncured adhesive layer. A peripheral mask lies between the adhesive layer and the cover glass, such that corresponding peripheral portions of the adhesive layer are masked from direct illumination through the cover glass. Actinic light from the LEDs is injected into a masked portion of the adhesive layer through an adhesive edge, after such light is redirected by the anamorphic optical system. The anamorphic optical system captures or receives light from the LEDs and redirects that light to spread the light out along the adhesive edge, while also focusing the received light onto the adhesive edge in a reference plane perpendicular to the adhesive edge.

We also disclose apparatuses for bonding a cover glass to a display housing in an uncured or non-bonded display assembly to produce a bonded display assembly, where the uncured display assembly includes the cover glass, the display housing, an adhesive layer therebetween, and a peripheral mask attached to the cover glass, the adhesive layer including a masked portion covered by the peripheral mask, and an unmasked portion, the adhesive layer initially being uncured, the adhesive layer also terminating to form an adhesive edge proximate the masked portion. The apparatus includes a stage, a light source arrangement, and an anamorphic optical system. The stage is adapted to receive the uncured display assembly. The light source arrangement includes a series of discrete LEDs that are mounted such that, when the uncured display assembly is received on the stage, the series of discrete LEDs extends along a direction generally parallel to the adhesive edge. The anamorphic optical system is mounted to receive light from the series of discrete LEDs, and to redirect the received light such that, when the uncured display assembly is received on the stage, the redirected light spreads out along the adhesive edge, while also being focused onto the adhesive edge in a reference plane perpendicular to the adhesive edge.

Related methods, systems, and articles are also discussed.

These and other aspects of the present document will be apparent from the detailed description below. In no event, however, should the above summaries be construed as limitations on the claimed subject matter, which subject matter is defined solely by the attached claims, as may be amended during prosecution.

### BRIEF DESCRIPTION OF DRAWINGS

FIG. 1 is a schematic perspective view of a system in which a masked cover glass is to be applied and bonded to a display housing to produce a bonded display assembly;

FIG. 2 is a schematic side or sectional view of a display assembly during a curing operation, where actinic radiation such as UV light passes through the cover glass to cure a transparent adhesive layer, but portions of the adhesive layer are shielded by a peripheral mask;

FIG. 3 is a schematic side or sectional view of a display housing;

FIG. 4 is a schematic side or sectional view of a display assembly that may be bonded or non-bonded, this view showing, among other things, how the edge of the adhesive layer may be recessed within the assembly;

FIG. 5 is a schematic perspective view of a display assembly being side-illuminated with UV light or other actinic radiation from a light source arrangement comprising a series of discrete LEDs;

FIG. 6 is a schematic side or sectional view of a side or end portion of a display assembly, illuminated by an LED or other discrete light source spaced apart from an edge of the adhesive layer, the view also illustrating the inefficient optical coupling represented by the narrow capture angle θ;

FIG. 7 is a schematic side or sectional view of a side or end portion of a display assembly, illuminated by an LED or other discrete light source, and where an anamorphic optical system, such as a suitable cylindrical lens, receives light from the LED and redirects the received light onto the edge of the adhesive layer, providing a more efficient optical coupling as represented by a substantially wider capture angle θ;

FIG. 7A is a schematic side or sectional view similar to FIG. 7, but where a reference plane associated with spreading of the LED light by the anamorphic optical system is not parallel to a reference plane defined by the adhesive layer;

FIGS. 8A and 8B are schematic perspective views of a discrete LED irradiating the edge of an adhesive layer with light using an anamorphic optical system, FIG. 8A illustrating how the anamorphic optical system focuses light from the LED onto the adhesive edge in a reference plane perpendicular to the adhesive edge, and FIG. 8B illustrating how the anamorphic optical system allows light from the LED to spread out in a perpendicular plane;

FIG. 9 is a schematic side or sectional view of a system in which light from an LED is collected and focused onto the adhesive layer edge by an anamorphic system comprising two parallel cylindrical lenses;

FIG. 10 is a schematic perspective view of a cylindrical lens, or other anamorphic optical element, whose cross-sectional shape has a constant radius of curvature;

FIG. 11 is a schematic perspective view of a cylindrical lens, or other anamorphic optic, whose cross-sectional shape has a variable radius of curvature to reduce aberrations;

FIG. 12 is a schematic side or sectional view of a system in which light from an LED is collected and focused onto the adhesive layer edge by an anamorphic system comprising a cylindrical mirror;

FIG. 13 is a schematic top view of a bonding or curing apparatus having a stage, a light source arrangement comprising four series of discrete LEDs, one series for each side of the stage, the apparatus also including anamorphic optical systems, in the form of two cylindrical lenses, disposed between each series of LEDs and the stage, the figure also showing a display assembly disposed on the stage;

FIG. 14 is a schematic front view of LED devices arranged to form a series of discrete LEDs, the series configured as two rows of LEDs;

FIG. 15A is a graph of irradiance versus position along the adhesive edge, for a setup in which only air is present between the series of discrete LEDs and the adhesive edge; and

FIG. 15B is a graph similar to FIG. 15A, but where a suitable anamorphic optical system is disposed between the series of LEDs and the adhesive edge.

In the figures, like reference numerals designate like elements.

### DETAILED DESCRIPTION OF ILLUSTRATIVE EMBODIMENTS

As mentioned above, we have developed techniques for more effectively curing the transparent adhesive layer of a display assembly in which a mask layer covers or shades peripheral portion(s) of the adhesive layer. The techniques can be used to provide a faster, easier, and more spatially uniform adhesive bond. When cured, the adhesive layer secures and bonds the display assembly together.

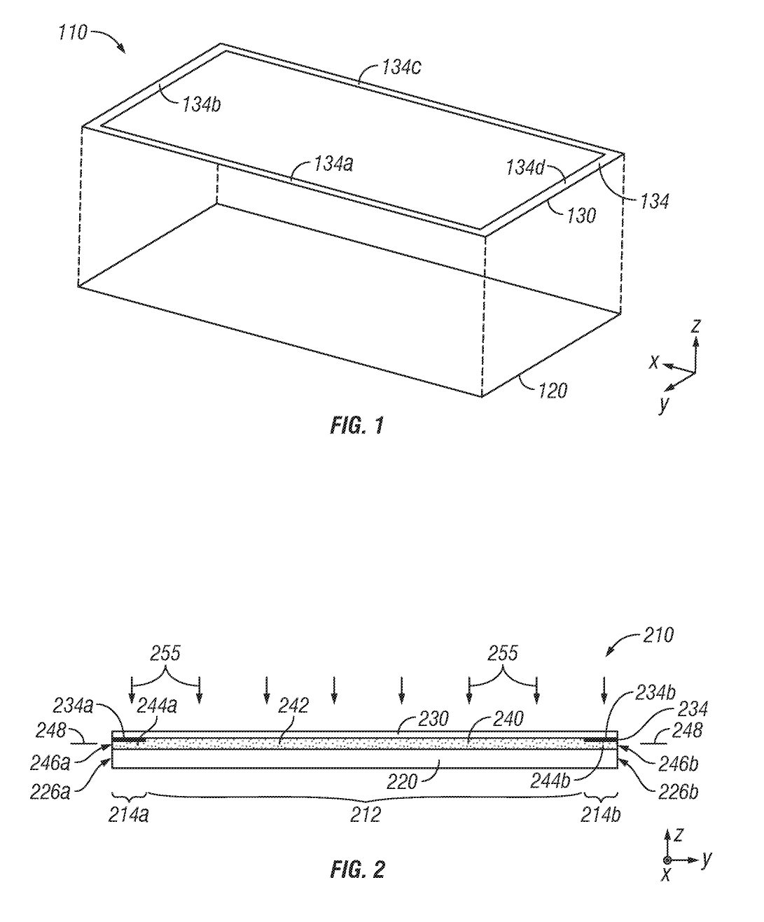

FIG. 1 illustrates a display assembly of interest in a schematic, exploded view. The display assembly 110 includes a cover glass 130 and a display housing 120, which are to be joined together and bonded by a transparent adhesive layer (not shown) to form a bonded display assembly. For convenience of description in this figure and in later figures, the display assembly 110 is shown in the context of a Cartesian x-y-z coordinate system, where the cover glass, the display housing, and the adhesive layer each lies generally in the x-y plane, or in a plane that is parallel to the x-y plane. Similar x-y-z coordinate systems are repeated and included in many of the other figures herein. This however should not be construed to mean that the disclosed display assemblies are limited to only planar configurations.

Mechanically, the cover glass 130 is typically rigid or at least semi-rigid to reinforce the structure of the finished display assembly. Optically, the cover glass 130 is generally transparent to visible light to allow a user to see the image produced by the display panel within the display housing 120, with minimal reduction in brightness or clarity. The cover glass may thus be or comprise a layer of clear glass, or in some cases an optically clear plastic such as polymethylmethacrylate (PMMA) or polycarbonate. The thickness of the glass or plastic may depend on the physical size of the cover glass 120 in terms of its length, width, diagonal span, or other characteristic lateral dimension, but may typically range from about 200 micrometers for small displays on portable devices to about 10 mm for much larger displays, e.g., for billboards or other large outdoor applications. It is desirable in most cases to keep the cover glass, and all other components of the display assembly 110, as thin as reasonably possible, so that the finished LCD device is as thin, low-profile, and light (not heavy) as possible.

Significantly, the cover glass 130 is “masked” in the sense that it comprises or has applied to it a mask layer or mask 134 that is limited to areas at or near the periphery of the cover glass 130. Such a mask 134 is opaque or substantially opaque, for example, having an average visible light transmission of less than 5%, or less than 1%. The low transmission may be due to optical absorption, optical scattering, or a combination thereof. The mask 134 is limited to peripheral areas in order to hide or conceal components of the display housing 120 located at the periphery of the display housing that would otherwise be visible to the user, such as light sources, mechanical systems, or electrical components, while not substantially encroaching upon the useable area of the display in the large central region of the cover glass 130. The mask 134 shown in FIG. 1 is composed of four distinct mask portions 134a, 134b, 134c, and 134d corresponding to the four sides or edges of the cover glass 130 or display housing 120. These mask portions form a rectangular shape similar in appearance to a narrow picture frame. In alternative embodiments, the mask 134 may have mask portions along only part of (less than all of) the perimeter of the cover glass 130. For example, any one, or any two, or any three of the mask portions 134a, 134b, 134c, 134d may in some cases be omitted from the display assembly 110. Each mask portion 134a, 134b, 134c, 134d has in-plane length and width dimensions that will depend on the size of the display assembly 110. The width of a given mask portion may in some embodiments be as small as about 1 mm or even less (e.g. down to 0.1 mm), and in other embodiments may be as large as about 10 or even 25 mm, but these values should not be construed as limiting.

The mask 134 may be made of any suitable opaque material, for example, a black or dark ink printed onto a surface of the cover glass 130, or a metal or other reflective or non-reflective opaque material selectively coated onto peripheral portions of the cover glass 130. Materials such as one or more of a polymeric film, a deposited metal or inorganic material, a printed ink, and pigments such as titanium dioxide can be used. The mask 134 significantly blocks visible radiation from the edges of the display panel, and in some cases can form a frame through which the image area of the display is viewed. As a layer, the mask 134 has a thickness that is usually much less than that of the cover glass 130, but this need not be the case in all embodiments.

The display housing 120—shown only schematically in FIG. 1—is a subassembly that includes a layer of liquid crystal (LC) material sealed between two transparent plates, and two polarizers are usually also included on opposite sides of the LC layer. Details of typical display housings are discussed further below. The display housing 120 and cover glass 130 may have the same or similar size and shape, e.g. they may be congruent or similar rectangles as shown in FIG. 1, such that at least some corners and edges of the cover glass 130 line up with corresponding features of the display housing 120 in the finished, bonded display assembly. However, this is not the case in all embodiments, as explained further below. Furthermore, other rectangular and non-rectangular shapes are also contemplated for the display assembly 110 and its constituent components.

In FIG. 2 we see a schematic side or sectional view of a display assembly 210 during a curing operation. The display assembly 210 includes a cover glass 230 and a display housing 220, between which is a transparent adhesive layer 240. The display assembly 210 also includes a peripheral mask layer 234, which includes a first mask portion 234a and a second mask portion 234b located on the same surface but at opposite peripheral ends of the cover glass 230. The mask portions 234a, 234b may for example correspond to mask portions 134a, 134c respectively of FIG. 1.

In the figure, the display assembly 210 is assumed to be non-bonded or uncured, by which we mean the adhesive layer 240 is uncured. This is apparent from the figure because actinic radiation or light 255 is being directed at the adhesive layer 240 through the cover glass 230 for the purpose of curing the adhesive layer 240. Eventually, after sufficient exposure to the actinic light 255, curing of the adhesive layer 240 can be considered complete. The reader familiar with organic chemistry will appreciate that curing is a process in which a monomer, an oligomer, or both are polymerized, causing an increase in the molecular weight of the material, and that the transition of a material from being (substantially) fully uncured to being (substantially) fully cured is an incremental process in which the material exhibits progressively greater levels of partial curing.

While we acknowledge this fact, in order to avoid becoming unnecessarily mired in this level of detail and to simplify our discussion of the invention, for purposes of this document (unless otherwise indicated to the contrary), we refer to an adhesive layer, or a display assembly containing such an adhesive layer, as “cured” or “bonded” when the degree of partial curing is high enough to satisfy a specified curing condition, whereas the adhesive layer or display assembly is considered “uncured” or “non-bonded” if such specified curing condition is not satisfied. We define the specified curing condition as follows: (a) at least 20% of the carbon-carbon double bonds (for example in a given masked portion of the adhesive layer, or in all such masked portions) have been converted or reacted, as measured by FT-IR spectroscopy at the 6100-6200 cm⁻¹ band, or (b) the adhesive layer exhibits a mechanical property wherein G′/G″>1 at room temperature and at 1 Hz via DMA, or (c) both (a) and (b).

The adhesive layer 240 may be any suitable adhesive material that is sufficiently transparent. In an uncured state, the adhesive layer may be liquid and flowable, but in other cases it need not be liquid, e.g., it may be solid or substantially solid. In a cured state, the adhesive layer is solid or substantially solid, e.g., it may be a flowable material of extremely high viscosity. In the cured state, and in most cases in the uncured state, the adhesive layer is substantially transparent, i.e., it has a high average transmission over the visible wavelength spectrum. Not counting Fresnel reflections at the outer major surfaces, the adhesive layer may have an average transmission over visible wavelengths of at least 80%, or at least 90%, or at least 95%. Known materials for use as the adhesive layer may include (depending on specific requirements of the intended application) any of the available 3M™ Optically Clear Adhesive (OCA) products, including product codes 8211, 8212, 8213, 8214, and 8215.

During fabrication of the display assembly 210, before the cover glass 230 and display housing 220 are brought together to form the uncured display assembly, the uncured adhesive may initially be coated in a layer onto, or otherwise be applied to, (a) the lower major surface of the cover glass, or (b) the upper major surface of the display housing, or (c) some uncured adhesive may be applied to the cover glass, and some may be applied to the display housing. In any of these cases, after the adhesive application procedure, the two parts are then brought together to form the uncured display assembly 210.

Adhesive materials of interest for use in the layer 240 are curable by UV light or other actinic light, but may also be at least partially curable with heat. The actinic light 255 may be ultraviolet (UV) light, or light of other wavelengths or bands of wavelengths, that interacts with the material composition of the adhesive layer 240 to promote chemical curing of the adhesive. In exemplary embodiments, the actinic light 255 is in the “A” region of the UV spectrum, i.e., in a wavelength range from 315 to 400 nm, rather than in the shorter wavelength UVB (280 to 315 nm) or UVC (100 to 280 nm) ranges, but this should not be construed in an unduly limiting way. Violet light, at the short wavelength end of the visible spectrum close to the UV spectrum, may also be used for curing in some cases. Generally, light in the UV spectrum, or short wavelength visible light such as blue or violet light, is more effective as actinic radiation than longer wavelength light, such as light in the infrared region of the spectrum, or long wavelength visible light, because of the higher quantum energy associated with the shorter wavelength radiation. However, long term or high exposure levels of short wavelength light such as UV light can sometimes cause yellowing or other damage in optical plastics or other optical materials.

The adhesive layer 240 may be or comprise a UV curable pressure-sensitive adhesive (PSA), as well as a liquid optically clear adhesive. Optically clear adhesives may be used in a transfer tape format, for example, where a liquid adhesive composition precursor is applied between two siliconized release liners, at least one of which is transparent to UV radiation that is useful for curing. The adhesive composition can then be cured (polymerized) by exposure to actinic radiation at a wavelength at least partially absorbed by a photoinitiator contained therein. A thermally activated free-radical initiator may also be used, where the liquid adhesive composition is coated between two siliconized release liners and exposed to heat to complete the polymerization of the composition. A transfer tape that includes a PSA can be thus formed. The formation of a transfer tape can reduce stress in the adhesive by allowing the cured adhesive to relax before lamination. For example, in a typical assembly process, one of the release liners of the transfer tape can be removed and the adhesive can be applied to the display housing. Then, the second release liner can be removed and lamination to the cover glass can be completed. In cases where the cover glass and the display housing are rigid, adhesive bonding can be assisted with vacuum lamination equipment to assure that bubbles are not formed in the adhesive or at the interfaces between the adhesive and the bonded components. The assembled components may then be submitted to an autoclave step to finalize the bond and make the display assembly 210 free of lamination defects.

In cases where a partially cured adhesive transfer tape is laminated between a masked cover glass (e.g. printed with an ink to form a peripheral mask) and a display housing, prevention of optical defects can be challenging because the partially cured adhesive may have to conform to a sometimes large ink step (e.g., 50-70 micrometers), and the total adhesive thickness acceptable in the display may for example only be 150-250 micrometers. Completely wetting this large ink step during initial assembly can be important, because any trapped air bubbles may become difficult to remove in subsequent display assembly steps. The optically clear adhesive transfer tape may desirably have sufficient compliance (for example, low shear storage modulus, G′, at lamination temperature, typically 25° C., of <10e5 Pascal (Pa) when measured at 1 Hz frequency) to enable good ink wetting, by being able to deform quickly, and to comply to the sharp edge of the ink step contour. The adhesive of the transfer tape may also have sufficient flow to not only comply with the ink step but also wet more completely to the ink (mask) surface. The flow of the adhesive can be reflected in the high tan delta value of the material over a broad range of temperatures, e.g., tan δ>0.5 between the glass transition temperature (Tg) of the adhesive (measured by DMTA) and about 50° C. or slightly higher. The stress caused by the rapid deformation of the optically clear adhesive tape by the ink step requires the adhesive to respond much faster than the common stress caused by a coefficient of thermal expansion mismatch, such as in polarizer attachment applications where the stress can be relieved over hours instead of seconds or shorter. However, even those adhesives that can achieve this initial ink step wetting may still have too much elastic contribution from the bulk rheology, which can cause the bonded components to distort acceptably. Even if the bonded display components are dimensionally stable, the stored elastic energy (due to the rapid deformation of the adhesive over the ink step) may find a way to relieve itself by constantly exercising stress on the adhesive, eventually causing failure. Thus, as in the case of liquid bonding of the display components, the design of a transfer tape to successfully bond the display components requires a delicate balance of adhesion, optics, drop test tolerance, as well as compliance to high ink steps, and good flow even when the ink step pushes into the adhesive layer up to as much as 30% or more of its thickness.

Inspection of FIG. 2 reveals that while most of the actinic light 255 passes through the cover glass 230 to cure the adhesive material in the transparent adhesive layer 240, portions of the adhesive layer 240 are shielded or shadowed by the opaque mask 234. In this regard, as a result of the mask 234, the display assembly 210 can be divided into a central unmasked region 212, and peripheral masked regions 214a, 214b. In the unmasked region 212, the actinic light 255 passes through the cover glass 230 and reaches the large central unmasked portion 242 of the adhesive layer 240, where it is absorbed and its energy is used to crosslink molecules of the uncured adhesive. In the masked regions 214a, 214b, direct illumination of the masked portions 244a, 244b of the adhesive layer 240 is substantially or greatly diminished, depending on the angle(s) of incidence of the actinic light 255. (In the figure, the propagation direction of the light 255 is shown as being normal (perpendicular) to the cover glass 230, with an angle of incidence of 0 degrees, but the reader will understand the light 255 may be incident over a range of incidence angles from 0 to 90 degrees. Such light that propagates obliquely is refracted towards the perpendicular direction (z-axis) relative to its propagation direction in air as it passes through the cover glass 230 and the adhesive layer 240.) Some indirect illumination of the masked portions 244a, 244b by the actinic light 255 may occur by secondary processes, e.g. by reflection or scattering of the actinic light 255 from surfaces or regions in the unmasked portion 242 of the adhesive layer. In any case, the flux level of the actinic light 255 in the masked portions 244a, 244b is diminished relative to the flux level the unmasked portion 242, which can give rise to problems such as those mentioned above—longer curing times, greatly increased UV light intensity needed for curing, or only partial curing of the shadowed portion of the adhesive layer, as well as possible toxicity and sensitization concerns for users.

After curing is complete and the finished display assembly is incorporated into a LC display system, visible light from a backlight (not shown) disposed beneath or behind the assembly 210 can, in the unmasked region 212 of the assembly 210, pass through the active area of the display housing, then through the adhesive layer 240, and then through the cover glass 230 before reaching the eye of the user.

Additional features of the display assembly 210 are also labeled in FIG. 2, and will be briefly described here. The adhesive layer 240 lies generally in, or defines, a reference plane 248. The reference plane 248 may be parallel to the x-y plane. The adhesive layer 240 also terminates to form a side surface or edge 246a proximate the masked portion 244a. On the opposite end of the adhesive layer, the layer 240 terminates to form a side surface or edge 246b proximate the masked portion 244b. The adhesive edges 246a, 246b both extend along longitudinal directions or axes that are parallel to the x-axis. The display housing 220 similarly terminates on its opposed sides or ends to form edges 226a, 226b. In the figure, the edges 246a, 246b of the adhesive layer are shown as being aligned or coplanar with the edges 226a, 226b respectively of the display housing. However, these edges may in other embodiments not be aligned with each other, as shown further below.

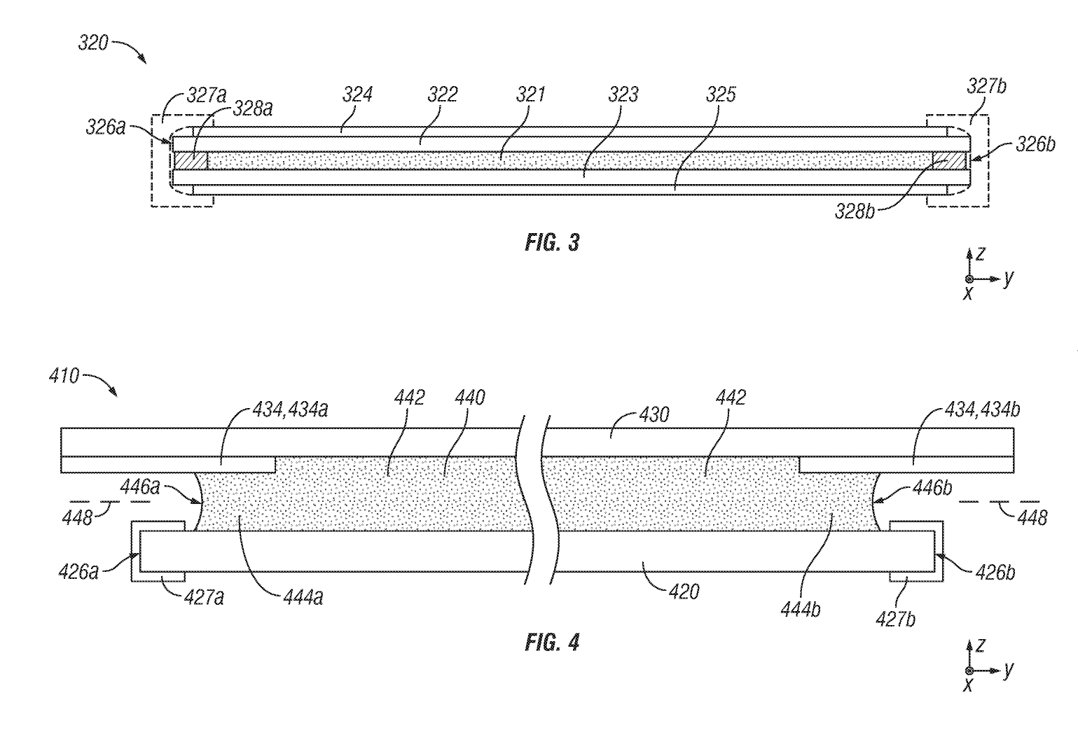

Turning now to FIG. 3, this figure schematically shows elements, components, and features that may be present in a display housing for use in the disclosed display assemblies. The display housing 320, shown as extending generally parallel to the x-y plane, includes a layer of liquid crystal (LC) material 321 sealed between a front transparent plate 322 and a back transparent plate 323. A sealant, comprising sealant portions 328a, 328b, prevents the LC material 321 from leaking. A front polarizer 324 is applied to the front transparent plate 322, and a back polarizer 325 is applied to the back transparent plate 323. These two polarizers are typically absorbing polarizers, and they are typically in a crossed configuration, whereby their respective pass axes (and their respective block axes) form an angle of about 90 degrees in the x-y plane. The polarizers 324, 325 may be applied to their respective plates 322, 323 by a suitable optically clear adhesive.

To the extent we may wish to refer to side surfaces or edges 326a, 326b of the display housing 320, such edges may be a complex assortment or group of edges of the constituent layers of the display housing, in those cases where such constituent edges are not in alignment. The display housing 210 may also include a bezel made of metal, plastic, or other suitable bendable material(s). The bezel, which includes bezel portions 327a, 327b, may wrap entirely around the edge of the display housing 320, or it may wrap around only a portion thereof. The bezel may also serve to hold together and reinforce the constituent elements of the display housing 320.

In FIG. 4 we see in schematic form a display assembly 410 that may be bonded or non-bonded, i.e., the transparent adhesive layer 440 may be cured or uncured. The adhesive layer 440 contacts on a front major surface thereof a cover glass 430, and on a back major surface thereof a display housing 420. The adhesive layer 440, cover glass 430, and display housing 420 may be the same as or similar to other adhesive layers, cover glasses, and display housings discussed herein. The adhesive layer 440 extends along or defines a reference plane 448 parallel to the x-y plane. The adhesive layer 440 also terminates at outer ends or edges 446a, 446b. Each of the adhesive edges 446a, 446b extends along a direction or axis that is parallel to the x-axis. Surface forces between the transparent adhesive and surfaces in contact with the adhesive layer 440 may cause the adhesive edges 446a, 446b to curve or bow inwardly (as shown) or outwardly in a meniscus, rather than being substantially flat.

The cover glass 430 includes, or has applied to one or both major surfaces thereof, an opaque mask layer or mask 434, which may be the same as or similar to other masks discussed herein. The mask 434, which comprises opposed mask portions 434a, 434b, shadows or shields portions of the adhesive layer in such a way as to define an unmasked portion 442 of the adhesive layer 440 and peripheral masked portions 444a, 444b of the adhesive layer. The adhesive edge 446a is disposed proximate the masked portion 444a, and the adhesive edge 446b is disposed proximate the masked portion 444b. The adhesive layer 440 in fact contacts the surface of the mask portions 434a, 434b in the vicinity of the adhesive edges 446a, 446b, respectively.

The display housing 420 has outer edges 426a, 426b as shown, which are covered by bezel portions 427a, 427b, the bezel portions being part of a bezel which may wrap entirely or partially around the display housing 420. The adhesive layer 440 has a lateral dimension (e.g. length or width) less than that of the cover glass 430, and also less than that of the display housing 420, such that the adhesive edges 446a, 446b are recessed to some extent within the display assembly 410. One reason a display designer may wish to recess the adhesive edges 446a, 446b relative to the display housing 420 is to prevent the adhesive, when it is in a liquid or flowable state, from making contact with, and then wicking underneath, the bezel of the display housing.

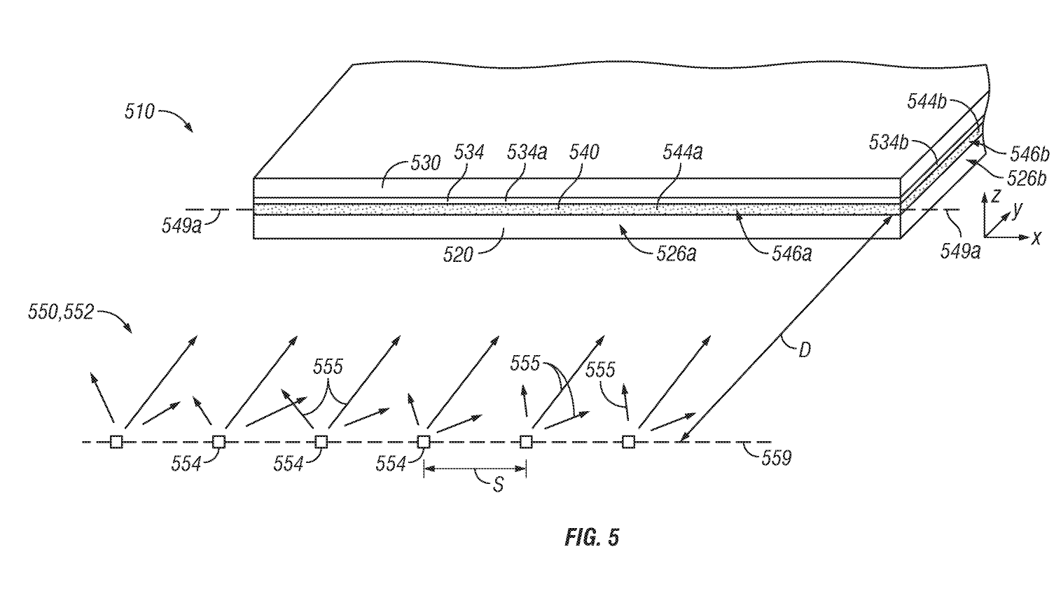

We have already discussed problems that may result from the masked adhesive layer portions experiencing a slower curing than the unmasked adhesive layer portion. One approach to solving this problem is to supplement, or replace, the front actinic exposure (represented by actinic light 255 in FIG. 2) with side- or end-actinic light exposure. One embodiment of this approach is shown schematically in FIG. 5.

In this embodiment, a display assembly 510 that includes a cover glass 530, a display housing 520, and an adhesive layer 540 therebetween, is shown being illuminated from the side or end with actinic light 555 from a light source arrangement 550. If desired, additional actinic light from other light sources (not shown) may impinge on the front surface of the cover glass 530, similar to FIG. 2. The cover glass 530 includes, or has applied to it, a mask layer or mask 534 at peripheral portions of the cover glass. The cover glass 530, mask 534, adhesive layer 540, and display housing 520 may be the same as or similar to corresponding elements discussed elsewhere herein. At or near one edge of the display assembly, the mask 534 has a first mask portion 534a, the display housing has a first edge 526a, and the adhesive layer has a first masked portion 544a and terminates at a first edge 546a proximate the masked portion 544a. At or near an intersecting edge of the display assembly, the mask 534 has a second mask portion 534b, the display housing has a second edge 526b, and the adhesive layer has a second masked portion 544b and terminates at a second edge 546b proximate the masked portion 544b.

Actinic light 555 from the light source arrangement 550 illuminates the adhesive layer 540 from the side or edge, and enters the masked portion 544a of the adhesive layer 540 predominantly through the adhesive edge 546a. Such actinic light 555—whose properties may be the same as or similar to the actinic light 255 discussed above—injected into the adhesive layer 540 in this fashion accelerates or promotes curing in the masked portion 544a by increasing the flux of actinic light in that portion of the adhesive layer. If desired, other light source arrangements similar to the arrangement 550 may be used to side-illuminate other edges and masked portions of the adhesive layer 540, such as the adhesive edge 546b and the masked portion 544b.

Although a variety of light sources may be used to provide the actinic light 555 used for curing the adhesive, the light source arrangement 550 is shown to use a series 552 of small, discrete light sources 554, which we identify specifically as light emitting diodes (LEDs). LEDs provide some distinguishing features over other kinds of light sources that make them particularly suited for this application, although other features of LEDs present challenges. Before discussing these distinguishing features, we digress briefly to help explain what is meant by the term LED for purposes of this document. For our purposes, unless otherwise indicated, “LED” refers to a diode that emits light, whether visible, ultraviolet, or infrared, although ultraviolet and short wavelength visible wavelengths are of particular applicability to the disclosed embodiments for reasons discussed elsewhere. The term includes incoherent encased or encapsulated semiconductor devices marketed as “LEDs”, whether of the conventional or super radiant variety, that emit incoherent light. The term also includes semi-coherent, or even coherent, light sources such as laser diodes (LDs), such coherent or semi-coherent sources typically having a spectral bandwidth substantially narrower than that of incoherent sources. The LED may be packaged to include a phosphor (or it may illuminate a remotely disposed phosphor) to convert short wavelength light to longer wavelength light. An “LED die” is an LED in its most basic form, i.e., in the form of an individual component or chip made by semiconductor processing procedures. The component or chip can include electrical contacts suitable for application of power to energize the device. The individual layers and other functional elements of the component or chip are typically formed on the wafer scale, and the finished wafer can then be diced into individual piece parts to yield a multiplicity of LED dies.

LEDs are currently available with relatively high electrical-to-optical efficiencies, and high brightnesses in the blue and UV regions of the spectrum, of particular applicability in material curing applications. LEDs are also physically robust, not easily susceptible to damage or breakage, and they are known to have good reliability and long lifetimes even though their outputs degrade gradually over time.

The emitting die or chip of an LED is small, for example, square in shape with a side dimension of typically about 1 mm or less. As a result of the small size of the LED emitting area, in order to provide adequate actinic illumination along the entire adhesive edge 546a, the light source arrangement 550 includes a plurality of LEDs 554 grouped in a series. In the illustrated embodiment, the LEDs 554 are spread out in a line along an axis 559. The axis 559 may be parallel to an axis 549a along which the adhesive edge 546a extends, and spaced apart from the axis 549a or from the adhesive edge 546a by a distance D as shown. The LEDs 554 may have a uniform spacing S along the axis 559, or their spacing may be non-uniform or variable.

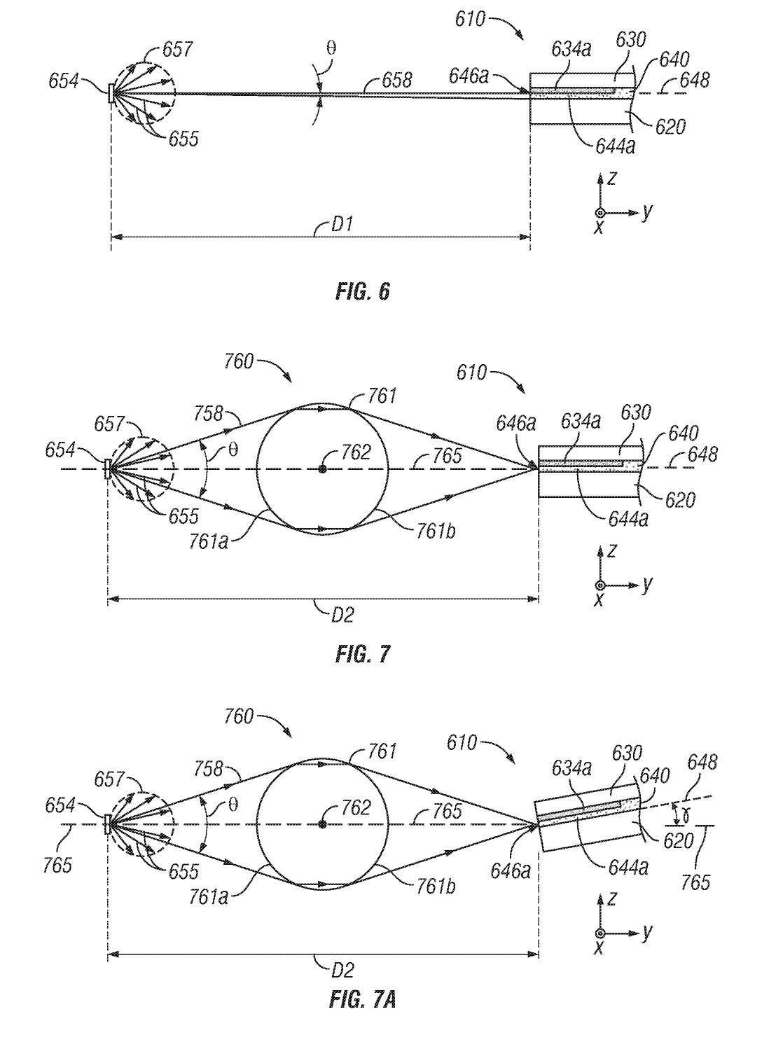

One disadvantage of the setup of FIG. 5 is the geometrical inefficiency relating to the coupling geometry from the LED to the adhesive edge. The LED emits light over a wide range of directions, but only a small fraction of that emitted light enters the masked portion of the adhesive layer through the adhesive edge. This situation is illustrated in FIG. 6.

In the figure, a display assembly 610 includes a cover glass 630, a display housing 620, a transparent adhesive layer 640 therebetween, and an opaque mask that includes a mask portion 634a disposed at a periphery of the cover glass 630. The cover glass 630, mask portion 634a, display housing 620, and adhesive layer 640 may be the same as or similar to corresponding elements discussed herein. The adhesive layer extends along or defines a reference plane 648, which may be parallel to the x-y plane. The mask portion 634a shields a masked portion 644a of the adhesive layer 640 from front illumination through the cover glass 630. Proximate the masked portion 644a, the adhesive layer 640 terminates to form an edge 646a.

A stationary, side-mounted discrete LED 654 is located a distance D1 from the adhesive edge 646a. The LED 654, which may be a non-encapsulated LED die, emits UV light or other actinic light 655. The LED 654 may be the same as or similar to any of the LEDs 554 discussed above, and the light 655 may likewise be the same as or similar to actinic light 555. The LED 654 may also be one LED in a series of discrete LEDs, as discussed above. The bare emitting surface of the LED 654 emits the light 655 in a wide angle output distribution or emission cone, which is labeled 657 in the figure. The output distribution 657 may for example be a Lambertian distribution. In any case, the LED 654 emits actinic light 655 over a fairly wide range of angles and directions. In the plane of the figure (the y-z plane), the portion of the light 655 that is directed toward, and propagates into, the adhesive edge 646a is represented by the light capture envelope 658. The capture envelope 658 is characterized by a capture angle θ.

Aspects of the arrangement of FIG. 6 can be modified to increase the amount of the actinic light 655 from the LED 654 that impinges on the adhesive edge 646a in the y-z plane, but there are limits and tradeoffs when making such modifications. For example, the capture angle θ of the capture envelope 658 can be increased by decreasing the distance D1. However, decreasing D1 produces increased non-uniformity along the length of the adhesive edge 646a (i.e., hot spots along the x-axis near each LED 654), for a given LED-to-LED spacing (see spacing S in FIG. 5). In another approach, the LED 654 could be encapsulated in a conventional domed encapsulant. This would cause the output distribution 657 to become narrower and more directed along the y-axis, thus increasing the amount of actinic light contained within the capture envelope 658. However, the output distribution would also become narrower along the x-axis, which would again increase the non-uniformity of actinic light along the length of the adhesive edge 646a. Furthermore, the encapsulant material would be susceptible to degradation and yellowing from extended exposure to high flux levels of short wavelength radiation.

To increase the flux of the actinic light impinging upon the adhesive edge without some of the negative consequences discussed above, in an arrangement that still uses a series of discrete LEDs as the source of side-illuminated actinic light, we propose introducing a suitable anamorphic optical system to help capture and focus or concentrate actinic light in one plane, while allowing the actinic light to spread out along the adhesive edge in an orthogonal plane. A simple form of such an optical system is a cylindrical lens or mirror.

Turning then to FIG. 7, presented there is an arrangement for curing the adhesive layer of a display assembly much like that of FIG. 6, except that an anamorphic optical system is included. Like elements are identified with like reference numerals—such as display assembly 610, cover glass 630, display housing 620, transparent adhesive layer 640, opaque mask with mask portion 634a, reference plane 648, masked adhesive layer portion 644a, adhesive layer edge 646 , LED 654, actinic light 655, and output distribution 657—and their descriptions need not be repeated here. FIG. 7 differs from FIG. 6 by the introduction of anamorphic optical system 760, which receives the actinic light 655 from the LED 654, and redirects the received light onto the adhesive edge 646a of the transparent adhesive layer 640.

In the illustrated embodiment, the anamorphic optical system 760 is a single cylindrical lens 761. The cylindrical lens extends along a longitudinal axis 762 which is perpendicular to the plane of the figure, and hence parallel to the x-axis. The axis 762 may be an axis of symmetry of the lens. The term “cylindrical” is used herein in its mathematical sense; as such, the reader should understand that although the cross-sectional shape of the cylindrical lens 761 in the y-z plane is constant along the axis 762, and the cross-sectional shape may in some cases be circular, the cross-sectional shape is not restricted to a circle, but may be any closed shape, for example, an ellipse, an oval, a many-sided polygon, or combinations thereof, such as where one or some portions of the cross-sectional shape are curved, and one or some other portions are straight or segmented.

The lens 761 has a first optical surface 761a and a second optical surface 761b. Both of these optical surfaces are curved in the illustrated embodiment in the y-z plane. Both optical surfaces thus provide refractive optical power in the y-z plane as a function of the curvature of the surfaces and the refractive index of the lens 761. Because of this optical power, the lens 761 is able to intercept or receive actinic light 655 that propagates within a light capture envelope 758 characterized by a capture angle θ in the y-z plane, and focus a that light onto the adhesive edge 646a. Note that the capture angle θ for the envelope 758 is substantially wider than the capture angle θ for comparable capture envelope 658 above.

The distance D2 from the LED 654 to the adhesive edge 646a in FIG. 7 may be adjusted relative to the distance D1 in FIG. 6 to accommodate optimal LED-to-lens and lens-to-adhesive edge distances to ensure maximum illumination of the adhesive edge 646a. The LED-to-lens and lens-to-adhesive edge distances may furthermore be selected such that the adhesive edge 646a resides at a paraxial image plane for the LED 654. That is, the lens 761 may image (in the y-z plane) the emitting surface of the LED 654 directly onto the adhesive edge 646a. Furthermore, the distances can be selected to provide a desired magnification factor between the object (LED 654) and the image (adhesive edge 646a). The desired magnification factor may depend on the relative z-axis dimensions of the LED 654 and the adhesive edge 646a, but may typically lie in a range from 0.25 to 4, or from 0.5 to 2, or the desired magnification may be about 1. In some cases it may be advantageous to slightly blur the actinic light 655 focused by the cylindrical lens 761 by positioning the adhesive edge 646a a small distance away from (in front of or behind) the paraxial image plane.

A reference plane 765 can be drawn that passes through the center of the LED 654 and that contains the longitudinal axis 762 of the cylindrical lens 761. In a cross-section of the cylindrical lens 761 through this reference plane 765, the optical surfaces 761a and 761b become straight lines with no curvature. Consequently, actinic light 655 that propagates in or close to this plane 765 will experience little or no focusing by the lens 761. Such light is thus relatively free to spread out within the plane 765 as the light travels from the LED 654 to the adhesive edge 646a.

In alternative embodiments, the cylindrical lens 761 may be replaced or supplemented with an optical element or a combination of optical elements selected from: one or more cylindrical lenses, one or more cylindrical mirrors, and one or more non-cylindrical anamorphic lenses or mirrors. An anamorphic lens or mirror that is not cylindrical has at least one optical surface with a non-zero curvature (and thus a non-zero optical power) in a reference plane counterpart to reference plane 765. Despite the non-zero optical power in the reference plane (for example where the anamorphic lens has a weak positive focusing power in the reference plane), such a non-cylindrical anamorphic lens or mirror may nevertheless be used by itself, or in combination with other suitable lenses or mirrors, to spread out actinic light 655 from the LED 654 along the adhesive edge 646a, provided the LED 654 is appropriately positioned relative to such non-cylindrical anamorphic lens or mirror.

In the embodiment of FIG. 7, the LED 654, cylindrical lens 761, and display assembly 610 are positioned such that the reference plane 765 defined by the LED and cylindrical lens is coplanar, or nearly coplanar, with the reference plane 648 defined by the adhesive layer of the display assembly. Other configurations are also possible. One such other configuration is shown in FIG. 7A, where like elements are identified with like reference numerals, with no further description needed. The setup of FIG. 7A differs from that of FIG. 7 only by a shift in the orientation of the display assembly 610 relative to the LED/cylindrical lens combination such that the reference planes 648 and 765 are no longer coplanar, and no longer parallel. In FIG. 7A, the planes 648, 765 exhibit a non-zero and significant relative tilt angle γ. Despite this relative tilt, the anamorphic optical system 761 of FIG. 7A (like the system 761 of FIG. 7) receives light from the discrete LED 654 and redirects the received light to spread out along the adhesive edge 646a, and focuses the received light onto the adhesive edge 646a in a reference plane (e.g. the y-z plane) perpendicular to the adhesive edge 646a.

The adhesive layer 640, at least in its uncured state, may have a refractive index for the actinic light 655 that is greater than or less than that of the cover glass 630, and greater than or less than that of the display housing 620 (or the portion of the display housing proximate the adhesive layer). By selecting the composition of the adhesive layer 640 such that its refractive index is greater than the cover glass 630, or greater than the display housing 620 (or portion thereof proximate the adhesive layer), or both, light guiding e.g. by total internal reflection at one or both major surfaces of the adhesive layer can occur to trap at least some of the side-injected light 655 in the adhesive layer 640, thus also increasing the curing depth and curing efficiency.

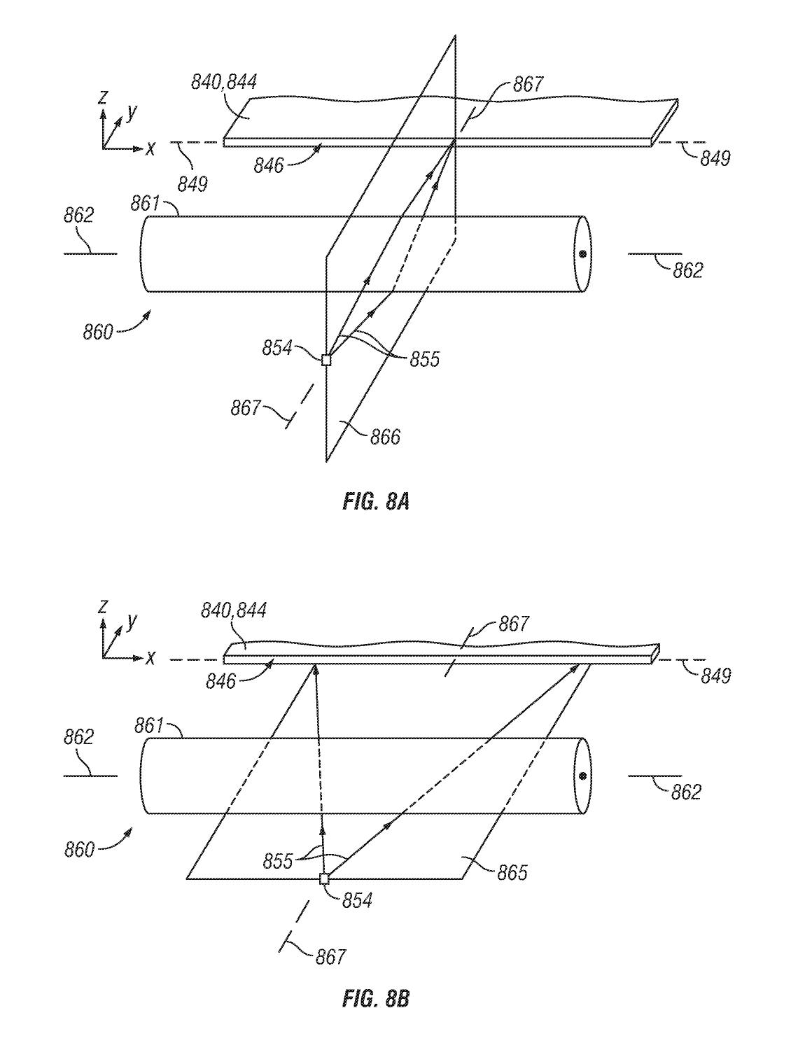

FIGS. 8A and 8B help illustrate some of the reference planes referred to above in connection with embodiments that include an anamorphic optical system. In these figures a discrete LED 854, which may be one of a series of discrete LEDs, emits actinic light 855, and some of that light is captured or received by an anamorphic optical system 860. The anamorphic system 860 then injects the received light into a masked portion of a transparent adhesive layer through an edge of the adhesive layer to cure the adhesive.

Still referring to FIGS. 8A and 8B, actinic light 855 from a discrete LED 854 is used to crosslink or cure an uncured transparent adhesive layer 840. The adhesive layer is part of a display assembly such as those of FIG. 2, 4, or 5, but other elements of the display assembly, such as the cover glass, mask, and display housing, are omitted from FIGS. 8A and 8B for ease of illustration. The adhesive layer 840 has a masked portion 844, and the layer 840 terminates to form an adhesive side surface or edge 846 proximate the masked portion 844, the adhesive edge extending along an axis 849. The adhesive layer 840 may reside in the x-y plane, or in a reference plane parallel to the x-y plane, and the axis 849 may be parallel to the x-axis.

An anamorphic optical system 860 is provided that intercepts or receives some of the actinic light 855 from the discrete LED 854. For simplicity, the system 860 is shown to have only one anamorphic lens 861. The lens 861 extends along a longitudinal axis 862, which may also be an axis of symmetry for the lens. The axis 862 is parallel to the x-axis and to the axis 849 associated with the adhesive edge 846. The lens 861 may be cylindrical, or it may be non-cylindrical, e.g., wherein its optical surfaces have a slight curvature in the x-y plane. The lens 861 may be made of any suitable optical material such as glass or plastic. Desirably, the optical material that is used is resistant to yellowing or other damage from prolonged exposure to UV or short wavelength light.

An optical axis 867 passes through the LED 854 and through the adhesive edge 846, and is perpendicular to the axis 849. The optical axis 867 may also intersect the longitudinal axis 862. A reference plane 866 is perpendicular to the adhesive edge 846, passes through the LED 854, and contains the optical axis 867. In this reference plane 866, the anamorphic lens 861 possesses optical power. The LED 854, the anamorphic lens 861, and the adhesive edge 846 are positioned with respect to each other so that actinic light 855 received by the lens 861 is focused onto the adhesive edge 846 in the reference plane 866.

Another reference plane 865 passes through the LED 854 and contains the longitudinal axis 849. The reference plane 865 may also contain the longitudinal axis 862 and the optical axis 867. The reference plane 865 is perpendicular to the reference plane 866. The reference plane 865 may in some cases be coplanar with the x-y plane, while in other cases there may be a nonzero angle of tilt γ between these planes. In the reference plane 865, the anamorphic lens 861 may possesses no optical power (if the lens is cylindrical), or a small amount of optical power (if the lens is non-cylindrical). The LED 854, the anamorphic lens 861, and the adhesive edge 846 are positioned with respect to each other so that actinic light 855 received by the lens 861 spreads out along the adhesive edge 846 in the reference plane 865. The spreading of the light in the plane 865 allows for a more uniform exposure of the masked portion 844 of the adhesive layer to the actinic light 855, and thus a more uniform curing of that portion of the adhesive layer.

In some cases, such as where the LED is or includes an incoherent LED die, the LED 854 may emit light 855 in an angular output distribution or emission cone that has the same or similar angular width (e.g. as determined by the full-angular-width-at-half-maximum (FWHM) intensity) in the reference plane 865 as in the reference plane 866. In other cases, such as where the LED is or includes a coherent source such as a laser diode, the LED 854 may emit light 855 in an angular output distribution or emission cone whose angular width (e.g. as determined by the FWHM intensity) is substantially narrower in one reference plane than the other. In such cases, the LED 854 is preferably oriented such that the narrower angular width is oriented perpendicular to the adhesive edge 846 (e.g., parallel to the reference plane 866), and the wider angular width is oriented parallel to the adhesive edge (e.g., parallel to the reference plane 865).

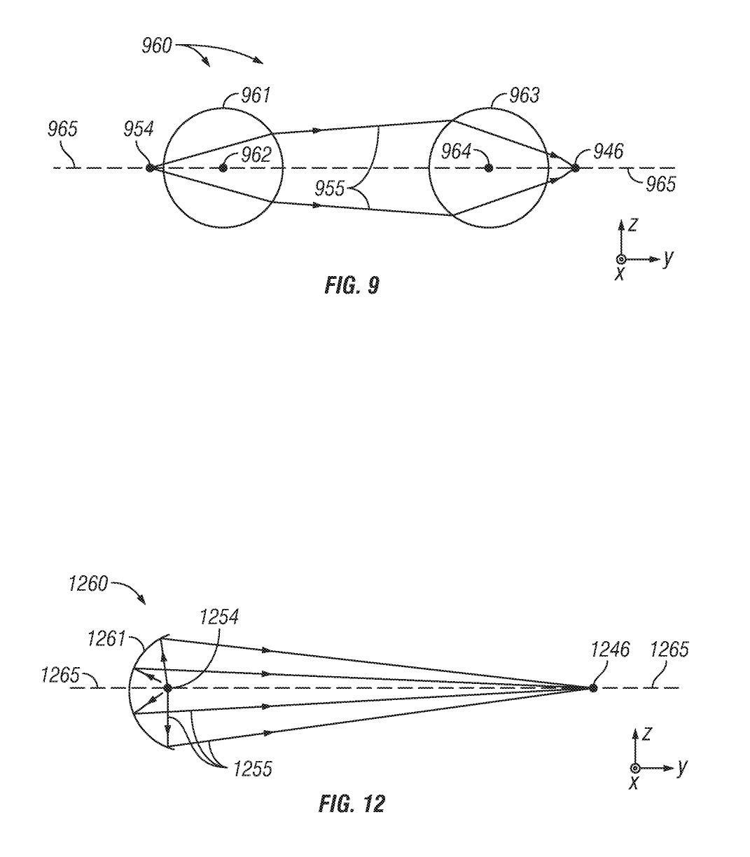

FIG. 9 shows a curing system in which an anamorphic optical system comprising two cylindrical lenses is used to collect and redirect actinic light from a discrete LED onto an edge of a masked adhesive layer in a display assembly to cure the adhesive layer. The LED is represented by point 954, and the edge of the adhesive layer is represented by point 946. The anamorphic optical system 960 is made up of two cylindrical lenses 961, 963, having respective longitudinal axes 962, 964. A reference plane 965 contains the axes 962, 964 as well as an optical axis, and passes through the LED 954 and through the adhesive edge 946, which is assumed to extend parallel to the x-axis (perpendicular to the plane of the figure). The optical powers and relative positions of the lenses 961, 963 are selected so that the LED 954 is imaged onto the adhesive edge 946 in the y-z plane, or in a broader sense so that actinic light 955 from the LED 954 is concentrated or focused onto the adhesive edge 946. In a perpendicular reference plane, light from the LED 954 that is captured by the anamorphic optical system 960 illuminates and spreads out along the adhesive edge 946.

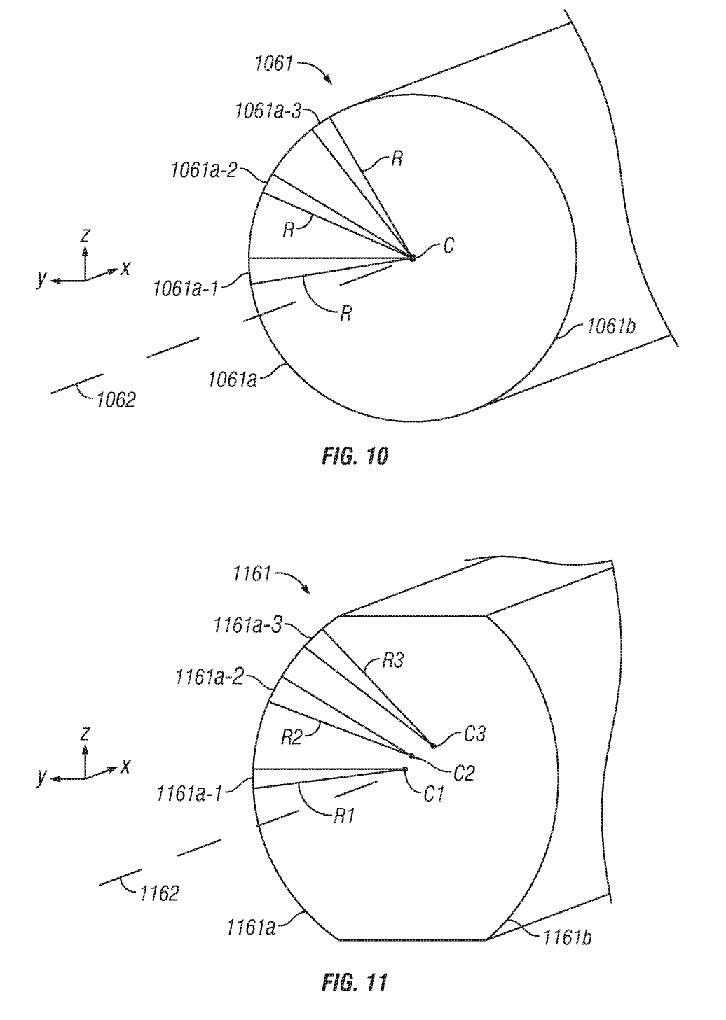

FIGS. 10 and 11 explore details of curved optical surfaces that may be used in some of the anamorphic lenses and mirrors disclosed herein. In FIG. 10, a cylindrical lens 1061 extends along a longitudinal axis 1061, which may also be an axis of symmetry. The axis 1061 is assumed to be parallel to the x-axis. A cross-section of the lens 1061 in the y-z plane reveals a curved shape for a first optical surface 1061a, and a curved shape for a second optical surface 1061b. The first optical surface 1061a is assumed to be a semicircle, i.e., an arc or curve of constant curvature. Thus, a first portion 1061a-1, a second portion 1061a-2, and a third portion 1061a-3 of the optical surface 1061a all have the same radius of curvature R and the same center of curvature C. In one possible embodiment, the lens 1061 may be circularly symmetric about the axis 1062, such that the cross-sectional shape formed by the first and second optical surfaces is a circle of radius R.

In FIG. 11, a cylindrical lens 1161 extends along a longitudinal axis 1161, which may also be an axis of symmetry. The axis 1161 is assumed to be parallel to the x-axis. A cross-section of the lens 1161 in the y-z plane reveals a curved shape for a first optical surface 1161a, and a curved shape for a second optical surface 1161b. The first optical surface 1161a has a variable radius of curvature. Thus, a first portion 1161a-1 of the surface 1161a has a first radius of curvature R1 and a first center of curvature C1, a second portion 1061a-2 of the surface 1161a has a second radius of curvature R2 and a second center of curvature C2, and a third portion 1161a-3 of the optical surface 1161a has a third radius of curvature R3 and a third center of curvature C3, where R1, R2, and R3 are unequal, and C1, C2, and C3 are also unequal. The variable radius of curvature across the optical surface 1161a may be tailored to reduce aberrations and increase the amount of flux from the discrete LED that is injected in to the edge of the adhesive layer. The second optical surface 1161b may also have a variable radius of curvature, e.g. it may be a mirror image of the surface 1161a, or it may have a constant curvature.

FIG. 12 shows another curing system in which an anamorphic optical system is used to collect and redirect actinic light from a discrete LED onto an edge of a masked adhesive layer in a display assembly to cure the adhesive layer. FIG. 12 is similar in that regard to FIG. 9, except that the two cylindrical lenses 961, 963 are replaced with a single cylindrical reflector 1261. The LED is represented by point 1254, and the edge of the adhesive layer is represented by point 1246. The anamorphic optical system 1260 is made up of one cylindrical mirror 1261, which may extend parallel to the x-axis (perpendicular to the plane of the figure). A reference plane 1265 contains an optical axis, and passes through the LED 1254 and through the adhesive edge 1246, which is also assumed to extend parallel to the x-axis (perpendicular to the plane of the figure). The optical power and relative position of the mirror 1261 is selected so that the LED 1254 is imaged onto the adhesive edge 1246 in the y-z plane, or in a broader sense so that actinic light 1255 from the LED 1254 is concentrated or focused onto the adhesive edge 1246. In a perpendicular reference plane, light from the LED 1254 that is captured by the anamorphic optical system 1260 illuminates and spreads out along the adhesive edge 1246.

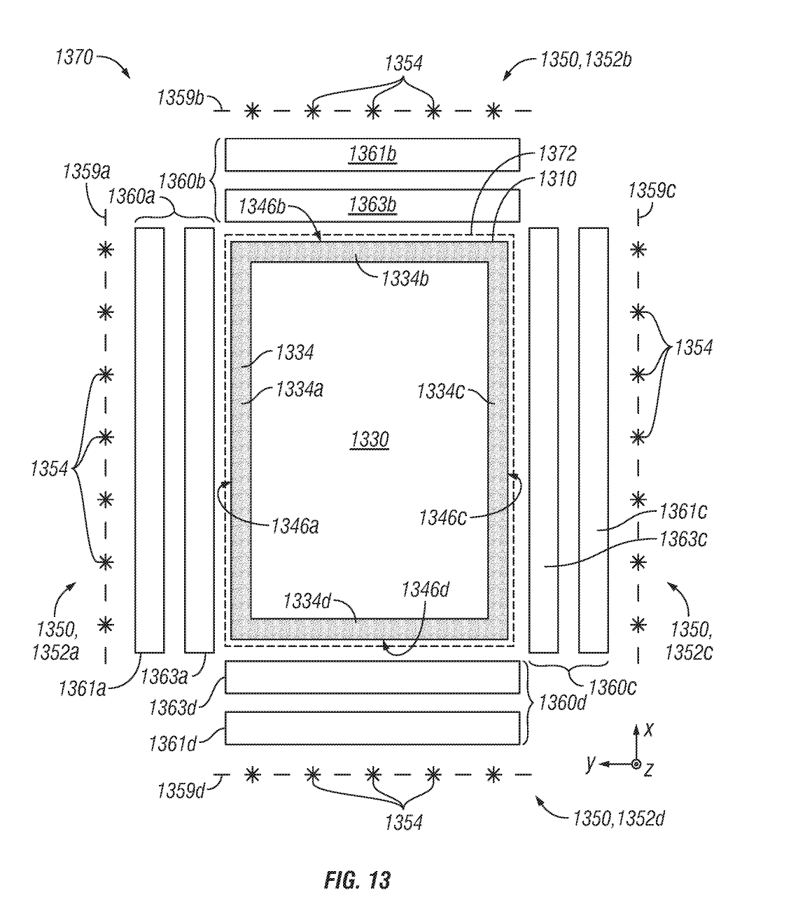

The foregoing lighting and curing systems can be used to construct an apparatus for bonding a cover glass to a display housing in an uncured display assembly to produce a bonded display assembly. Such an apparatus 1370 is shown schematically in FIG. 13. The apparatus 1370 is designed to receive an uncured display assembly, and to cure the adhesive layer—particularly the masked portions of the adhesive layer—using discrete LED sources of actinic light in a fast, efficient, and spatially uniform manner.

The apparatus 1370 comprises a stage 1372, which may extend parallel to the x-y plane, and upon which an uncured display assembly 1310 can be placed. For simplicity we assume the display assembly includes: a cover glass 1330; a mask 1334 having four mask portions 1334a, 1334b, 1334c, 1334d; an initially uncured adhesive layer that terminates to form four adhesive edges 1346a, 1346b, 1346c, and 1346d proximate corresponding masked portions of the adhesive layer; and a display housing, all arranged as discussed in detail above. Around the stage 1372 are mounted or otherwise arranged four side-illumination stations for efficiently coupling actinic light from discrete LEDs into masked portions of the adhesive layer when the display assembly 1310 is present on the stage 1372, one such station for each of the four masked portions and edges of the adhesive layer. The apparatus 1370 uses a light source arrangement 1350 of discrete LED sources 1354 divided into four distinct series.

A first side-illumination station uses a first series 1352a of LEDs 1354 and an anamorphic optical system 1360a proximate the series 1352a. In the first series 1352a, the LEDs 1354 are spaced apart along a first axis 1359a, which is parallel to the adhesive edge 1346a and parallel to the x-axis. The LEDs 1354 emit actinic light (see e.g. the series 552 of LEDs in FIG. 5), a portion of which is received by the anamorphic optical system 1360a. The anamorphic system 1360a redirects the received light to spread the light out along the adhesive edge 1346a, and to focus the light onto the adhesive edge 1346a in a reference plane parallel to the y-z plane. The anamorphic optical system 1360a is composed of two cylindrical lenses 1361a, 1363a, similar to the system of FIG. 9.

A second side-illumination station uses a second series 1352b of LEDs 1354 and an anamorphic optical system 1360b proximate the series 1352b. In the second series 1352b, the LEDs 1354 are spaced apart along a second axis 1359b, which is parallel to the adhesive edge 1346b and parallel to the y-axis. The LEDs 1354 emit actinic light, a portion of which is received by the anamorphic optical system 1360b. The anamorphic system 1360b redirects the received light to spread the light out along the adhesive edge 1346b, and to focus the light onto the adhesive edge 1346b in a reference plane parallel to the x-z plane. The anamorphic optical system 1360b is composed of two cylindrical lenses 1361b, 1363b, similar to the system 1360a.

A third side-illumination station uses a third series 1352c of LEDs 1354 and an anamorphic optical system 1360c proximate the series 1352c. In the third series 1352c, the LEDs 1354 are spaced apart along a third axis 1359c, which is parallel to the adhesive edge 1346c and parallel to the x-axis. The LEDs 1354 emit actinic light, a portion of which is received by the anamorphic optical system 1360c. The anamorphic system 1360c redirects the received light to spread the light out along the adhesive edge 1346c, and to focus the light onto the adhesive edge 1346c in a reference plane parallel to the y-z plane. The anamorphic optical system 1360c is composed of two cylindrical lenses 1361c, 1363c, similar to the system 1360a.

A fourth side-illumination station uses a fourth series 1352d of LEDs 1354 and an anamorphic optical system 1360d proximate the series 1352d. In the fourth series 1352d, the LEDs 1354 are spaced apart along a fourth axis 1359d, which is parallel to the adhesive edge 1346d and parallel to the y-axis. The LEDs 1354 emit actinic light, a portion of which is received by the anamorphic optical system 1360d. The anamorphic system 1360d redirects the received light to spread the light out along the adhesive edge 1346d, and to focus the light onto the adhesive edge 1346d in a reference plane parallel to the x-z plane. The anamorphic optical system 1360d is composed of two cylindrical lenses 1361d, 1363d, similar to the system 1360b.

In any or all of the four anamorphic optical systems, the two cylindrical lenses may be replaced with a single cylindrical lens, or a single cylindrical mirror, or non-cylindrical anamorphic lens(es) or mirror(s), or combinations thereof.

Upon placing the uncured display assembly on the stage 1372, the discrete LEDs 1354 in one, some, or all of the series 1352a, 1352b, 1352c, 1352d may be energized to provide the actinic light needed to cure the masked portions of the adhesive layer. Additional discrete LEDs (not shown) may be provided in an array on a cover or lid that fits over the stage 1372 and display assembly 1310 to provide front surface actinic light as shown and described in connection with FIG. 2 above. In this manner, substantially all portions of the adhesive layer, both masked and unmasked, can experience high flux levels of actinic light for faster and more spatially uniform curing results.

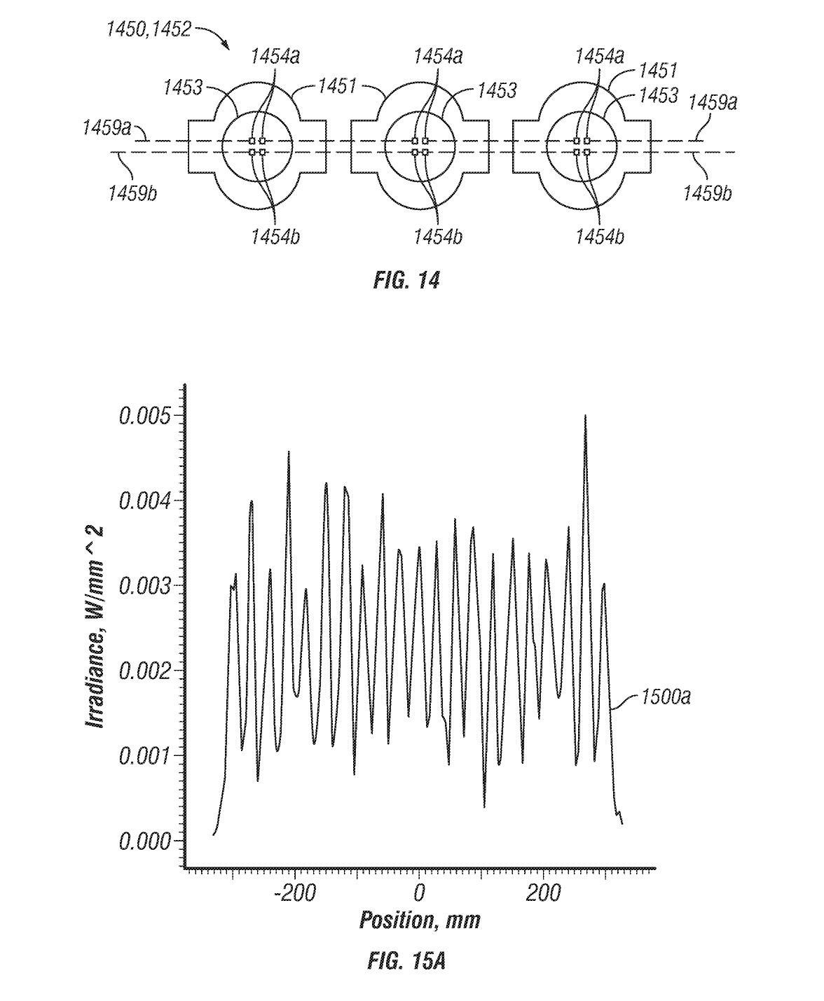

FIG. 14 illustrates a specific arrangement of LED devices that was used as the basis of a modeling simulation. In the simulation, three LED devices 1451 were provided to define a light source arrangement 1450 that included a series of discrete LEDs 1454a, 1454b. Each LED device 1451 included four LEDs: two upper LEDs 1454a and two lower LEDs 1454b arranged in a square formation as shown. These four LEDs were disposed behind a disk-shaped cover glass 1453, which was in turn disposed on a circuit board. The LEDs 1454a, 1454b were assumed to be identical to each other, each having a 1×1 mm emitting area, each emitting the same UV actinic light, and each assumed to have a Lambertian output distribution or emission cone. The three LED devices 1451 were positioned together as shown in FIG. 14 such that the six LEDs 1454a formed a first row along a first axis 1459a, and the six LEDs 1454b formed a second row along a second axis 1459b. This light source arrangement is referred to hereafter as the modeled light source arrangement.

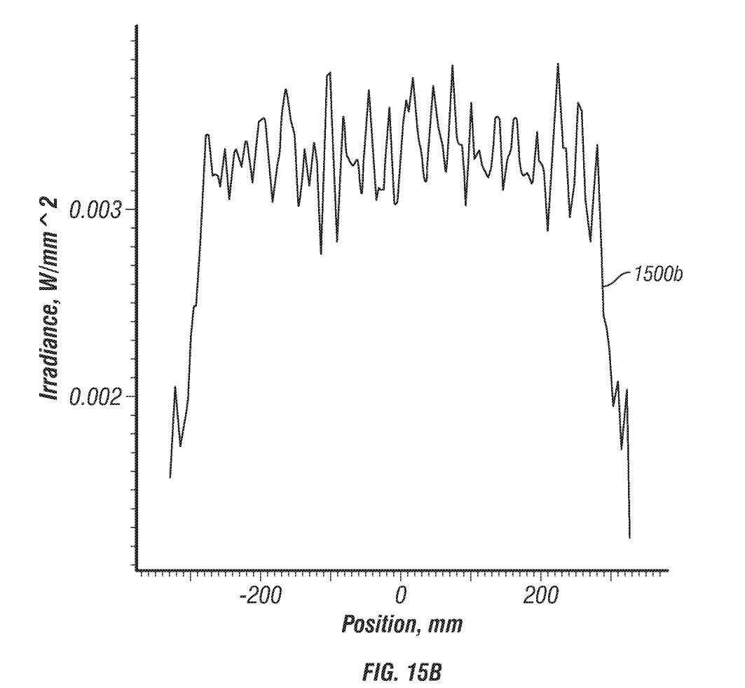

The modeled light source arrangement was used to simulate the light intensity as a function of position along the (modeled) adhesive edge of a display assembly. In a first simulation, the modeled light source arrangement was used in a system similar to that shown in FIG. 9. With reference to that figure, the modeled light source arrangement was oriented to face the cylindrical lens 961, with the modeled light source arrangement centered at the point 954, and with the axes 1459a, 1459b (FIG. 14) extending parallel to the x-axis. The edge of the adhesive layer was simulated as a narrow rectangular detector plane centered at the point 946 and extending parallel to the x-axis, the width of the rectangle (i.e., its dimension parallel to the z-axis) being 0.150 mm. The cylindrical lenses 961, 963 were assumed to have a refractive index of 1.53, and each was assumed to have a circular cross-sectional shape with a radius of 7.5 mm. The center-to-center distance between the cylindrical lenses 961, 963 was 30 mm. Optical software was then used to calculate the intensity of the actinic light (originating from the LEDs in the modeled light source arrangement) at the edge of the adhesive layer, as a function of position along the adhesive edge. The calculated light intensity versus position is shown as curve 1500b in FIG. 15B.

For comparison, another simulation was done. This simulation was the same as the prior simulation, except that the anamorphic optical system 960 was removed, and the distance between the modeled light source arrangement and the adhesive edge was shortened to the point where the average light intensity at the adhesive edge was the same as in the earlier simulation. The resulting calculated light intensity versus position on the adhesive edge is shown as curve 1500a in FIG. 15A. Comparison of FIGS. 15A and 15B demonstrates that the simulated anamorphic optical system provides better uniformity for curing the adhesive layer than by simply placing the LED sources closer to the adhesive edge.

Unless otherwise indicated, all numbers expressing quantities, measurement of properties, and so forth used in the specification and claims are to be understood as being modified by the term “about”. Accordingly, unless indicated to the contrary, the numerical parameters set forth in the specification and claims are approximations that can vary depending on the desired properties sought to be obtained by those skilled in the art utilizing the teachings of the present application. Not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, to the extent any numerical values are set forth in specific examples described herein, they are reported as precisely as reasonably possible. Any numerical value, however, may well contain errors associated with testing or measurement limitations.

Various modifications and alterations of this invention will be apparent to those skilled in the art without departing from the spirit and scope of this invention, and it should be understood that this invention is not limited to the illustrative embodiments set forth herein. The reader should assume that features of one disclosed embodiment can also be applied to all other disclosed embodiments unless otherwise indicated. It should also be understood that all U.S. patents, patent application publications, and other patent and non-patent documents referred to herein are incorporated by reference, to the extent they do not contradict the foregoing disclosure.

1. A method of bonding a cover glass to a display housing to provide a bonded display assembly, the method comprising:
providing a light source arrangement including a first series of discrete LEDs;
providing an assembly comprising the cover glass, the display housing, an adhesive layer therebetween, and a peripheral mask between the cover glass and the adhesive layer, wherein the adhesive layer:
is initially uncured,
includes a first masked portion covered by the peripheral mask, and an unmasked portion, and
terminates to form a first adhesive edge proximate the first masked portion;
providing a first anamorphic optical system proximate the first series of discrete LEDs to receive light from the first series of discrete LEDs and to redirect the received light to (a) spread out along the first adhesive edge, and (b) focus the received light onto the first adhesive edge in a first reference plane perpendicular to the first adhesive edge; and
energizing the first series of discrete LEDs so that light from the first series of discrete LEDs, after being redirected by the first anamorphic optical system, enters the adhesive layer through the first adhesive edge to cure at least the first masked portion of the adhesive layer.

2. The method of claim 1, wherein the adhesive layer defines a second reference plane, and wherein the second reference plane is perpendicular to the first reference plane.

3. The method of claim 2, wherein the providing the first anamorphic optical system is carried out such that the first anamorphic optical system spreads out the received light in the second reference plane.

4. The method of claim 1, further comprising:
positioning the assembly proximate the light source arrangement such that the first series of discrete LEDs extends along a direction generally parallel to the first adhesive edge.

5. The method of claim 1, wherein providing the first anamorphic optical system includes providing a first cylindrical lens between the first series of discrete LEDs and the first adhesive edge.

6. The method of claim 5, wherein the first cylindrical lens has a cross-sectional shape whose radius of curvature is constant.

7. The method of claim 5, wherein the first cylindrical lens has a cross-sectional shape whose radius of curvature is variable.

8. The method of claim 5, wherein the first anamorphic optical system includes no cylindrical lenses other than the first cylindrical lens.

9. The method of claim 5, wherein the first anamorphic optical system includes the first cylindrical lens and a second cylindrical lens.

10. The method of claim 1, wherein the first anamorphic optical system includes a first cylindrical mirror.

11. The method of claim 1, wherein the first series of discrete LEDs comprises two distinct rows of LEDs, each such row extending along a direction generally parallel to the first adhesive edge.

12. The method of claim 1, wherein the light source arrangement further includes a second series of discrete LEDs, and wherein the adhesive layer terminates to form a second adhesive edge proximate a second masked portion of the adhesive layer, the second adhesive edge being opposite the first adhesive edge, the method further comprising:
providing a second anamorphic optical system proximate the second series of discrete LEDs to receive light from the second series of discrete LEDs and to redirect the received light to (a) spread out along the second adhesive edge, and (b) focus the received light onto the second adhesive edge in the first reference plane.

13. The method of claim 12, wherein the light source arrangement further includes a third series of discrete LEDs, and wherein the adhesive layer defines a second reference plane perpendicular to the first reference plane, and terminates to form a third adhesive edge proximate a third masked portion of the adhesive layer, the third adhesive edge being disposed between the first and second adhesive edges, the method further comprising:
providing a third anamorphic optical system proximate the third series of discrete LEDs to receive light from the third series of discrete LEDs and to redirect the received light to (a) spread out along the third adhesive edge, and (b) focus the received light onto the third adhesive edge in a third reference plane, the third reference plane being perpendicular to both the first and second reference planes.

14. The method of claim 13, wherein the light source arrangement further includes a fourth series of discrete LEDs, and wherein the adhesive layer terminates to form a fourth adhesive edge proximate a fourth masked portion of the adhesive layer, the fourth adhesive edge being opposite the third adhesive edge, the method further comprising:
providing a fourth anamorphic optical system proximate the fourth series of discrete LEDs to receive light from the fourth series of discrete LEDs and to redirect the received light to (a) spread out along the fourth adhesive edge, and (b) focus the received light onto the fourth adhesive edge in the third reference plane.

15. The method of claim 14, wherein the first, second, third, and fourth adhesive edges form a rectangular shape.

16. An apparatus for bonding a cover glass to a display housing in an uncured display assembly to produce a bonded display assembly, the uncured display assembly comprising the cover glass, the display housing, an adhesive layer therebetween, and a peripheral mask attached to the cover glass, the adhesive layer including a first masked portion covered by the peripheral mask, and an unmasked portion, the adhesive layer initially being uncured, and terminating to form a first adhesive edge proximate the first masked portion, the apparatus comprising:
a stage adapted to receive the uncured display assembly;
a light source arrangement including a first series of discrete LEDs that are mounted such that, when the uncured display assembly is received on the stage, the first series of discrete LEDs extends along a direction generally parallel to the first adhesive edge; and
a first anamorphic optical system mounted to receive light from the first series of discrete LEDs and to redirect the received light such that, when the uncured display assembly is received on the stage, the redirected light (a) spreads out along the first adhesive edge, and (b) is focused onto the first adhesive edge in a first reference plane perpendicular to the first adhesive edge.

17. The apparatus of claim 16, wherein the first anamorphic optical system includes a first cylindrical lens.

18. The apparatus of claim 17, wherein the first cylindrical lens has a cross-sectional shape whose radius of curvature is constant.

19. The apparatus of claim 17, wherein the first cylindrical lens has a cross-sectional shape whose radius of curvature is variable.

20. The apparatus of claim 17, wherein the first anamorphic optical system includes no cylindrical lenses other than the first cylindrical lens.

21-27. (canceled)
